(19) United States
(12) Patent Application Publication
(10) Pub. No.: US 2007/0066297 A1
(43) Pub. Date: Mar. 22, 2007

(54) Network monitoring system and method

(76) Inventor: Ghobad Heidari-Bateni, San Diego, CA (US)

Correspondence Address: MORRISON & FOERSTER LLP, 12531 HIGH BLUFF DRIVE, SUITE 100, SAN DIEGO, CA, 92130-2040, US

(21) Appl. No.: 11/230,785

(22) Filed: Sep. 20, 2005

(51) Int. Cl. H04Q 7/20

(52) U.S. Cl. 455/423

(57) ABSTRACT

A network monitoring device that can be configured to monitor the performance of a communication network is provided. The network monitoring device can be configured to monitor the performance of a wired or wireless network and can include an appropriate communication interface configured to associate the network monitoring device with the communication network and to receive device parameter information from one or more electronic devices associated with the network. Additionally, control logic configured to monitor device parameter information received by the wireless communication interface to ascertain one or more operating parameters of at least one of the plurality of electronic devices associated with the network can be provided. The control logic can be configured to analyze the operating parameters of electronic devices associated with the wireless communication network to determine whether one or more of the electronic devices associated with the wireless communication network are operating in accordance with network specifications. The control logic can also be configured to report the results of the analysis performed.

### FIELD OF THE INVENTION

The present invention relates generally to networking technology, and more particularly to system and method for monitoring a communication network.

### BACKGROUND OF THE INVENTION

The increasing popularity of electronic devices capable of capturing, storing and sharing various forms of electronic content and other information has brought about dramatic increases in the utilization of networking technology. Early networks were directed toward allowing multiple computer users to share information among one another. As technology has evolved networks are no longer limited to hardwired inter-computer connections. Indeed, contemporary network environments include networks offering wired and wireless connectivity among multiple electronic devices from the most complex of computer systems to the simplest of electronic devices.

With the recent proliferation of networking technology, especially high-bandwidth, low-power consumption, wireless communications technology, networks of various sizes and configurations are finding their way into applications where it was previously impractical to couple devices via a network. Various accepted and emerging standards, including standards such as IEEE 802.11a/b/g, IEEE 802.16, Bluetooth®, the MultiBand OFDM UWB (WiMeida-MBOA UWB), among others, are making networking capabilities practical, affordable and accessible in a greater number of diverse environments.

Many of these standards offer technology that is well suited for transfer of not only files and data, but also transfer of high-quality multimedia content, such as for example, photographs, video, music and other content items. With increasing bandwidth capabilities, modem technologies also allow high data rate operations such as, for example, wireless streaming of high-bandwidth content such as videos from a digital video recorder to a high-definition television, or wirelessly connectivity of a laptop computer, for example, to a conference room projector. As a result, the consumer is now offered the compelling proposition of eliminating hardwired cables and the plethora of incompatible plugs from their electronic devices in more and more applications.

Some of these networks also offer capabilities to allow new devices to be introduced to a network and automatically discover and communicate with one another, making network set-up and configuration a relatively easy task. Standardized network interfaces can also ease the interoperability hurdle that was prominent with hardwired devices of varying configurations.

These and other advances in technology have led to a widespread acceptance of networking technology in applications and environments where conventional networks were commercially impractical. Continued advances in networking technology are anticipated and will be necessary to stimulate further acceptance and to allow commercially viable interoperability with the increasingly available spectrum of electronic devices.

### BRIEF SUMMARY OF THE INVENTION

The present invention provides a network monitoring device configured to monitor the performance of a communication network, including a wireless communication network, the network monitoring device comprising: a wireless communication interface configured to associate the network monitoring device with the communication network and to receive device parameter information from one or more electronic devices associated with the network, first control logic configured to monitor device parameter information received by the wireless communication interface to ascertain one or more operating parameters of at least one of the plurality of electronic devices associated with the network, and to announce (transmit) to the network of devices up to date and accurate network parameters to obtain more optimal network operation; second control logic configured to analyze the operating parameters of electronic devices associated with the wireless communication network to determine whether one or more of the electronic devices associated with the wireless communication network are operating in accordance with network specifications; and third control logic configured to report the results of the analysis performed by the second control logic. Wherein, any of the first, second and third control logic can be implemented in a single electronic device or distributed among a plurality of electronic devices.

It should be clearly understood that the use of the terms “first control logic,” “second control logic,” “third control logic,” and other like terms throughout this document are used to facilitate description of the various features and functions of the invention and are not meant to dictate or even imply any physical or logical partitioning of the features and functions or of the instrumentalities used to implement the control logic. It should be also understood that control logic can be implemented using hardware, software, firmware or any combination thereof.

In accordance with one embodiment of the invention, communication interface comprises a wireless receiver and a signal conversion module configured to receive wireless signals from the wireless communication network and to convert information received thereby into a format that is intelligible by the first control logic. The device can also include a user interface configured to provide a user with information concerning whether one or more of the electronic devices associated with the wireless communication network are operating outside of network or user-defined specifications. The user interface can comprise at least one of a graphical, textual, audible or tactile interface.

In accordance with one embodiment of the invention the network monitoring device further comprises fourth control logic configured to take corrective action to resolve a situation where one or more of the electronic devices associated with the wireless communication network are operating outside of network specifications. The fourth control logic can be configured to send control information to the electronic device operating outside of network specifications, wherein said control information is operable to adjust one or more operating parameters of that electronic device. Alternatively, the fourth control logic can be configured to send control information to electronic devices associated with the wireless communication network, wherein said control information cam be operable to adjust one or more operating parameters of the electronic devices.

The network monitoring device can also be configured to include control logic configured to store information pertaining to the wireless communication network, said information comprising at least one of monitoring information determined by the first control logic and analysis information determined by the second control logic. The storing of information can facilitate analysis and reporting operations in a post processing mode, in addition to real-time or near-real-time processing and reporting.

In accordance with yet another embodiment of the invention a network monitoring system is provided and is configured to monitor performance of a communication network having a plurality of electronic devices, and comprises: a network monitoring module configured to monitor communication activities occurring on the communication network; an analysis module configured to determine whether one or more of the plurality of electronic devices are operating in accordance with at least one of a plurality of performance metrics; and a reporting module configured to report the results of the performance information including an identification of an electronic device that is not operating in accordance with at least one of a plurality of performance metrics. The network monitoring system can also include a logging module configured to store information concerning activity ascertained as a result of network monitoring and the analysis module can be configured to analyze network performance over a period of time.

The system can also include a user interface configured to provide a user with information concerning whether one or more of the electronic devices associated with the wireless communication network are operating outside of network specifications. The user interface can comprise at least one of a graphical, textual, audible or tactile interface.

In accordance with one embodiment of the invention the system can further include control logic configured to take corrective action to resolve a situation where one or more of the electronic devices associated with the communication network are operating outside of network specifications. The control logic can be configured to send control information to the electronic device operating outside of network specifications, wherein said control information is operable to adjust one or more operating parameters of that electronic device. The control logic can also be configured to send control information to electronic devices associated with the communication network, wherein said control information is operable to adjust one or more operating parameters of the electronic devices.

In accordance with yet embodiment of the invention the system can further include control logic configured to store information pertaining to the wireless communication network, said information comprising at least one of monitoring information determined by the first control logic and analysis information determined by the second control logic. The storing of information can facilitate analysis and reporting operations in a post processing mode, in addition to real-time or near-real-time processing and reporting.

In yet another embodiment of the invention, a network monitoring device is provided and is configured to monitor the performance of a communication network having a plurality of electronic devices associated therewith. The network monitoring device includes first control logic configured to receive one or more operating parameters from at least one of the plurality of electronic devices associated with the network; second control logic configured to analyze the operating parameters of electronic devices associated with the network to determine whether one or more of the electronic devices are operating in accordance with network or user-defined specifications; and third control logic configured to report the results of the analysis performed by the second control logic. The network monitoring device can also include a communication interface configured to allow the network monitoring device to communicate with one or more of the electronic devices associated with the communication network. The communication interface comprises can include a wireless receiver and a signal conversion module configured to receive wireless signals from a wireless communication network and to convert information received thereby into a format that is intelligible by the first control logic. The network monitoring device can also include a communication interface configured to allow the network monitoring device to communicate with an electronic device via a communication path other than the communication network.

The network monitoring device can also include a user interface configured to provide a user with information concerning whether one or more of the electronic devices associated with the wireless communication network are operating outside of network specifications. The user interface can comprise at least one of a graphical, textual, audible or tactile interface.

The network monitoring device can further include third control logic configured to take corrective action to resolve a situation where one or more of the electronic devices associated with the communication network are operating outside of network specifications. The third control logic can be configured to send control information to the electronic device operating outside of network specifications, wherein said control information is operable to adjust one or more operating parameters of that electronic device. The third control logic can also be configured to send control information to electronic devices associated with the wireless communication network, wherein the control information is operable to adjust one or more operating parameters of the electronic devices.

The network monitoring device can further include fourth control logic configured to store information pertaining to the communication network, the information comprising at least one of monitoring information determined by the first control logic and analysis information determined by the second control logic. The storing of information can facilitate analysis and reporting operations in a post processing mode, in addition to real-time or near-real-time processing and reporting.

In accordance with still another embodiment of the invention a network monitoring device is provided and is configured to monitor the performance of a communication network having a plurality of electronic devices associated therewith. The network monitoring device includes means for receiving one or more operating parameters from at least one of the plurality of electronic devices associated with the network; means for analyzing the operating parameters of electronic devices associated with the network to determine whether one or more of the electronic devices are operating in accordance with network or user-defined specifications; and means for reporting the results of the analysis performed by the second control logic. The network monitoring device can further include means for communicating with one or more of the electronic devices associated with the communication network as well as means for communicating with an electronic device via a communication path other than the communication network.

The network monitoring device can further include user interface means for providing a user with information concerning whether one or more of the electronic devices associated with the communication network are operating outside of network specifications, wherein the user interface means can comprise at least one of a graphical, textual, audible or tactile interface. The network monitoring device can also include means for addressing a situation where one or more of the electronic devices associated with the communication network are operating outside of network specifications.

The network monitoring device of can further include means for sending control information to the electronic device operating outside of network specifications, wherein the control information can be operable to adjust one or more operating parameters of that electronic device and operable to adjust one or more operating parameters of other electronic devices associated with the network.

The network monitoring device can further include means for storing information pertaining to the communication network, the information comprising at least one of monitoring information determined by the first control logic and analysis information determined by the second control logic. The storing of information can facilitate analysis and reporting operations in a post processing mode, in addition to real-time or near-real-time processing and reporting.

In still a further embodiment of the invention, a method for monitoring a communication network having a plurality of electronic devices associated therewith, is provided. The method comprises the steps of receiving one or more operating parameters or otherwise observing operating behavior from at least one of the plurality of electronic devices associated with the network; analyzing the operating parameters of electronic devices associated with the network to determine whether one or more of the electronic devices are operating in accordance with network specifications; and reporting the results of the analysis performed by the second control logic. The method can further include a step of communicating with one or more of the electronic devices associated with the communication network as well as a step of communicating with an electronic device via a communication path other than the communication network.

The method can further include a step of providing a user with information concerning whether one or more of the electronic devices associated with the communication network are operating outside of network specifications. The method can further include a step of addressing a situation where one or more of the electronic devices associated with the communication network are operating outside of network specifications. This can include a step of sending control information to the electronic device operating outside of network specifications, wherein the control information is operable to adjust one or more operating parameters of that electronic device, and can include a step of sending control information to electronic devices associated with the communication network, wherein the control information is operable to adjust one or more operating parameters of the electronic devices.

The method can also include a step of storing information pertaining to the communication network, the information comprising at least one of monitoring information determined by the first control logic and analysis information determined by the second control logic.

In yet one more embodiment of the invention a computer readable storage medium having executable program code thereon configured to monitor the performance of a communication network having a plurality of electronic devices associated therewith is provided. The executable program code comprising: first code directed to receiving one or more operating parameters from at least one of the plurality of electronic devices associated with the network; second code directed to analyzing the operating parameters of electronic devices associated with the network to determine whether one or more of the electronic devices are operating in accordance with network specifications; and third code directed to reporting the results of the analysis performed by the second control logic. The computer readable storage medium can further include code directed to communicating with one or more of the electronic devices associated with the communication network. Additionally, computer readable storage medium can further include code directed to communicating with an electronic device via a communication path other than the communication network.

In accordance with one embodiment of the invention, the computer readable storage medium can further include code directed to providing a user with information concerning whether one or more of the electronic devices associated with the communication network are operating outside of network specifications. Additionally, code directed to addressing a situation where one or more of the electronic devices associated with the communication network are operating outside of network specifications can be included. This can include code directed to sending control information to the electronic device operating outside of network specifications, wherein the control information is operable to adjust one or more operating parameters of that electronic device, as well as code directed to sending control information to electronic devices associated with the communication network, wherein the control information is operable to adjust one or more operating parameters of the electronic devices.

In accordance with yet another embodiment of the invention the computer readable storage medium can further include code directed to storing information pertaining to the communication network, the information comprising at least one of monitoring information determined by the first control logic and analysis information determined by the second control logic. The storing of information can facilitate analysis and reporting operations in a post processing mode, in addition to real-time or near-real-time processing and reporting.

Further features and advantages of the present invention, as well as the structure and operation of various embodiments of the present invention, are described in detail below with reference to the accompanying drawings.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of various features and aspects of the invention and shall not be considered limiting of the breadth, scope, or applicability of the invention. It should be noted that for clarity and ease of illustration these drawings are not necessarily made to scale.

FIG. 1 is a block diagram illustrating one possible configuration of a wireless network that can serve as an example environment in which the present invention can be implemented.

FIG. 2 is a block diagram illustrating an example architectural configuration of a network monitoring device in accordance with one embodiment of the invention.

FIG. 3 is an operational flow diagram illustrating the operation of the network monitoring device in accordance with one embodiment of the invention.

FIG. 4 is an operational flow diagram illustrating an example process for monitoring one or more networks in accordance with one embodiment of the invention.

### DETAILED DESCRIPTION OF THE INVENTION

The present invention is directed toward a system and method for monitoring the performance of a communication system such as, for example, a communication network. In one embodiment, the present invention provides capability to monitor the performance of one or more devices in a communication network and the performance of the communication network itself. In one embodiment this is accomplished by monitoring the performance of and operating parameters of one or more electronic devices connected to that network, which can indicate the operation, performance, and behavior, of the device in the network. In one embodiment, this information can also be used to determine the overall health of the network. In a preferred embodiment, the monitoring can be performed by allowing the present invention to be associated with or otherwise placed in communicative contact with the network to be monitored. In this manner, the invention can monitor signals and other information provided by the one or more electronic devices associated with the network and, through this monitoring, gather information about the network and the devices operating thereon.

For example, in one embodiment the present invention may be configured so as to monitor network traffic, network congestion, available bandwidth, and other valuable network parameters. Additionally, in one embodiment the present invention can be configured to monitor one or more parameters of the various electronic devices on the network such as, for example, device transmit power, receiver sensitivity (the previous two for wireless networks), past and future bandwidth consumption, conformance with protocols, bandwidth reservations, message acknowledgments, range, data rate capabilities, data formatting, compliance with priorities, and other like parameters. Network and device characteristics and parameters can be stored as well as monitored such that a record of network and device performance can be maintained and analyzed. Analysis results can also be stored for later recall and review and for further analysis purposes.

In accordance with another embodiment of the invention, network and device performance characteristics that are monitored can be analyzed so as to make determinations regarding the performance of the network relative to one or more network or user-defined benchmarks, standards or other metrics, and the performance or behavior of the devices in accordance with policies, standards, procedures, or other benchmarks or metrics. In this way, information that can ultimately be used to improve or optimize the network can be obtained and, preferably, beneficially applied. Thus, in accordance with yet another embodiment of the invention, results of the analysis can be provided to a user such that the user can take corrective action to improve the network.

As one example, it may be determined that a particular device on the network is not performing in accordance with specified requirements for bandwidth consumption. As a result, in this example this substandard device is consuming more than a device's allotted “share” of network resources to the detriment of other electronic devices and thus to the detriment of the performance of the network as a whole. This information can be provided to the user or any other controlling entity or device, and the user can determine whether to change the operating parameters of the device, remove the device from the network, live with the problem, or take other action as may be necessary or beneficial, depending on the user's needs or desires. Additionally, the present invention can be configured so as to take corrective action itself depending on the capabilities of the various devices in the network.

The present invention can be configured as a stand-alone device, wherein some of its functionality is embedded in a single device that can be introduced into the communication network such that functions such as monitoring and analysis can be performed by the stand-alone device. Additionally, some or all of the features and functionality of the present invention can be embedded with, or can be configured as added functionality to, another network device such as, for example, a personal computer or other electronic device operating on the network. Thus, for example, in this embodiment the functionality can be configured as a software application running on the computer's operating system or a hardware or hardware/software plug-in that can be connected via, for example, a USB or PCMCIA port. As another example, it can be an application that is downloaded to a user's cell phone and configured to run using processing and user interface capabilities associated with the cell phone. As will become apparent to one of ordinary skill in the art after reading this description, there are numerous ways in which some or all of the functionality of the present invention can be provided in one device or in a distributed fashion across a communication network. As such, there is great flexibility accorded with implementation of the invention using current as well as yet-to-be-developed technology and electronic devices.

Before describing the invention in detail, it is useful to describe an example environment in which the invention can be implemented. One such example is a wireless distributed network in which multiple electronic devices (for example, computers and computing devices, cellular telephones, personal digital assistants, motion and still cameras, among others) can communicate and share data, content and other information with one another. One example of such a distributed network is that specified by the MB-UWB standard (within WiMedia and Multi-Band OFDM Alliance). From time-to-time, the present invention is described herein in terms of a distributed network or in terms of the MB-UWB standard. Description in terms of these environments is provided to allow the various features and embodiments of the invention to be portrayed in the context of an exemplary application. After reading this description, it will become apparent to one of ordinary skill in the art how the invention can be implemented in different and alternative environments. Indeed, applicability of the invention is not limited to distributed wireless networks, nor is it limited to the MB-UWB standard described as one implementation of the example environment.

Most network standards specify policies or rules that govern the behavior of network connected devices. The MB-UWB standard specifies the mechanism and policies that are to be followed by W-USB and WiNet compliant devices in order to allow for an ad hoc and distributed network of such devices to operate efficiently. The network can be set up in a distributed fashion, meaning without the need for a host/server/master to control the operation of the other devices within its network neighborhood. As such, the entire operation of this network can be dependent on the proper operation of each individual device operating within the network. Thus, misbehavior from one of the devices, whether intentional or unintentional, could hinder the performance of the network and, depending on the severity of the misbehavior, render the entire network useless or at least inefficient.

Moreover, in a wireless networking environment, the knowledge of each device about its neighbors' existence or capabilities is not always reliable, due to the varying RF channel conditions. Thus, even if all devices operate as designed, there is no guarantee that they will know about each other and their capabilities well enough to allow for the ad hoc network to operate well. Also, wireless distributed networks sometimes suffer from a condition referred to as a hidden node, wherein a device on the network may be visible to some but not all the other devices on the network. This can lead to resource allocation problems and other inefficiencies that can further degrade the overall performance of the network.

In most distributed networks, the network of the devices is maintained by requiring all devices to announce parameters such as their presence, their capabilities and their intentions for reserving transmission slots and so on. For example, with the MB-UWB standard, this can be done during what are referred to as Beacon Period time slots. According to this standard, devices joining the network are expected to monitor the Beacon Period to learn about the network status and parameters before attempting to use the network. Devices are allowed to go to sleep for short or long periods. The exact mechanisms for detecting other users and their capabilities are often left to implementation. This means that there could be large performance deviations among devices in terms of how well they can adhere to the network rules or policies. Other networks also often have procedures facilitating an efficient sharing of network resources by the associated electronic devices.

Also, there could be rouge or malfunctioning or malicious devices that could easily disrupt the operation of the network. It would be difficult in a relatively large size network to determine which device is causing problems for the rest, especially if the problem is intermittent. Also, with many network implementations there are optional but recommended (not required) procedures within the standard that some device manufacturers may decide not to implement due to cost or power efficiency reasons. This measure could adversely hurt the performance of the network.

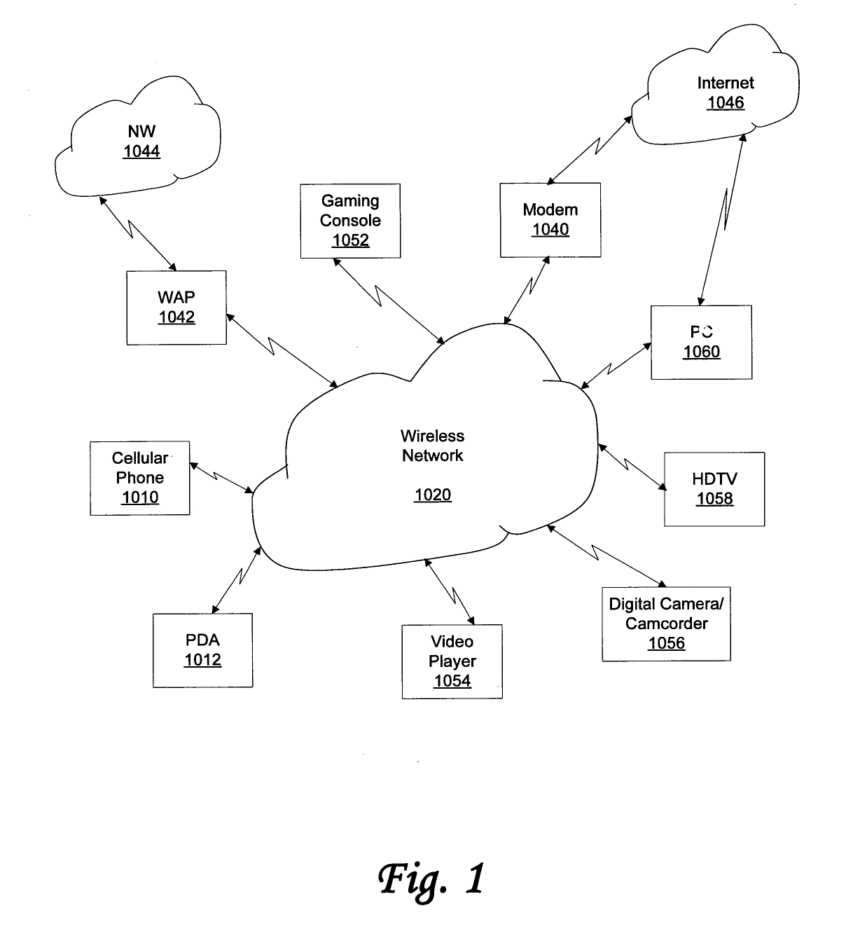

FIG. 1 is a block diagram illustrating one possible configuration of a wireless network that can serve as an example environment in which the present invention can be implemented. Referring now to FIG. 1, a wireless network 1020 is provided to allow a plurality of electronic devices to communicate with one another without the need for wires or cables between the devices. A wireless network 1020 can vary in coverage area depending on a number of factors or parameters including, for example, the transmit power levels and receive sensitivities of the various electronic devices associated with the network. Examples of wireless networks can include the various IEEE and other standards as described above, as well as other wireless network implementations.

With many applications, the wireless network 1020 operates in a relatively confined area, such as, for example, a home or an office. The example illustrated in FIG. 1 is an example of an implementation such as that which may be found in a home or small office environment. Of course wireless communication networks and communication networks in general are found in many environments outside the home and office as well. In the example illustrated in FIG. 1, wireless network 1020 includes a communication device to allow it to communicate with external networks. More particularly, in the illustrated example, wireless network 1020 includes a modem 1040 to provide connectivity to an external network such as the Internet 1046, and a wireless access point 1042 that can provide external connectivity to another network 1044.

Also illustrated in the example wireless network 1020 are portable electronic devices such as a cellular telephone 1010 and a personal digital assistant (PDA) 1012. Like the other electronic devices illustrated in FIG. 1, cellular telephone 1010 and PDA 1012 can communicate with wireless network 1020 via the appropriate wireless interface. Additionally, these devices may be configured to further communicate with an external network. For example, cellular telephone 1010 is typically configured to communicate with a wide area wireless network by way of a base station.

Additionally, the example environment illustrated in FIG. 1 also includes examples of home entertainment devices connected to wireless network 1020. In the illustrated example, electronic devices such as a gaming console 1052, a video player 1054, a digital camera/camcorder 1056, and a high definition television 1058 are illustrated as being interconnected via wireless network 1020. For example, a digital camera or camcorder 1056 can be utilized by a user to capture one or more still picture or motion video images. The captured images can be stored in a local memory or storage device associated with digital camera or camcorder 1056 and ultimately communicated to another electronic device via wireless network 1020. For example, the user may wish to provide a digital video stream to a high definition television set 1058 associated with wireless network 1020. As another example, the user may wish to upload one or more images from digital camera 1056 to his or her personal computer 1060 or to the Internet 1046. This can be accomplished by wireless network 1020. Of course, wireless network 1020 can be utilized to provide data, content, and other information sharing on a peer-to-peer or other basis, as the provided examples serve to illustrate.

Also illustrated is a personal computer 1060 or other computing device connected to wireless network 1020 via a wireless air interface. As depicted in the illustrated example, personal computer 1060 can also provide connectivity to an external network such as the Internet 1046.

In the illustrated example, wireless network 1020 is implemented so as to provide wireless connectivity to the various electronic devices associated therewith. Wireless network 1020 allows these devices to share data, content, and other information with one another across wireless network 1020. Typically, in such an environment, the electronic devices would have the appropriate transmitter, receiver, or transceiver to allow communication via the air interface with other devices associated with wireless network 1020. These electronic devices may conform to one or more appropriate wireless standards and, in fact, multiple standards may be in play within a given neighborhood. Although a specific example implementation is illustrated in FIG. 1, it will be apparent to one of ordinary skill in the art after reading this description how other wireless networks with alternative configurations of electronic devices can be configured in accordance with this environment.

Electronic devices operating as a part of wireless network 1020 are sometimes referred to herein as members or member devices of the network. Additionally, devices that communicate with a given network, whether they are members or merely in communication with the network are referred to herein as associated with the network.

Having thus described an example environment in which the invention can be implemented, various features and embodiments of the invention are now described in further detail. Description may be provided in terms of this example environment for ease of discussion and understanding only. After reading the description herein, it will become apparent to one of ordinary skill in the art that the present invention can be implemented in any of a number of different communication environments (including wired or wireless communication environments, and distributed or non-distributed networks) operating with any of a number of different electronic devices.

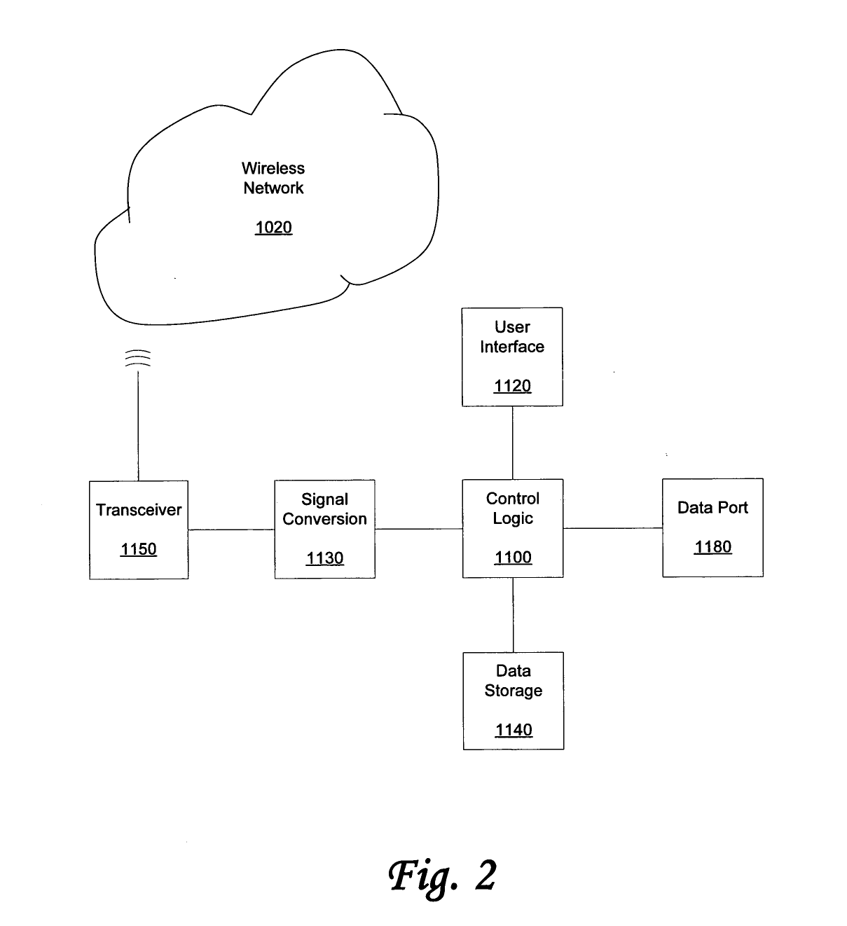

FIG. 2 is a block diagram illustrating an example architectural configuration of a network monitoring device in accordance with one embodiment of the invention. This diagram is intended to illustrate functional components that can be included with one or more embodiments of the present invention to provide the various features and functionality described herein. FIG. 2 should not, however, be construed so as to limit the implementation or configuration of the invention to the particular architecture or architectural configuration illustrated therein. Indeed, after reading this description, it will become apparent to one of ordinary skill in the art how to implement the various features and functionality of the present invention in a number of different architectural configurations either as a stand-alone device, embedded with another electronic devices, distributed among a stand-alone and one or more other electronic devices, or distributed among a plurality of electronic devices.

Referring still to FIG. 2, the example architecture includes control logic 1100, a user interface 1120, information storage 1140, a data port 1180, signal conversion 1130, and a communication transceiver 1150. Communication transceiver 1150 is included to provide communicative connectivity with the network that the device is intended to monitor. For example, in terms of the example environment described above with reference to FIG. 1, communication transceiver 1150 is a wireless communication transceiver configured to communicate via an appropriate air interface with other electronic devices associated with wireless network 1020. In implementations where the communication interface is wireless, a signal conversion module 1130 is typically provided with communication transceiver 1150 such that the communication interface can perform any appropriate modulation, demodulation, upconversion, or downconversion of the signals to allow communication between control logic 1100 and transceiver 1150. Thus, in this embodiment, transceiver 1150 and signal conversion 1130 may include RF, IF and mixed-signal functionality as appropriate to allow control logic 1100 to communicate information across wireless network 1020. In other embodiments, alternative signal conversion and data communication techniques can be utilized, as appropriate, depending on the communication requirements between wireless network 1020 (or other communication network or channel, depending on the application) and control logic 1100. As a result, the communication interface can be configured so as to receive information from the network in a form in which it is communicated across the network, convert or otherwise extract information from that communication, and provide that information in a form that is intelligible by control logic 1100.

Control logic 1100 can be implemented utilizing hardware, software, firmware, or any combination thereof. Preferably, control logic 1100 is implemented so as to provide monitoring, measurement, and analysis functions, as desired, for a network monitoring device. For example, control logic 1100 can be implemented as a microprocessor or other processor executing code to perform the desired functions. As additional examples, control logic 1100 can be implemented using ASICs or other components configured to perform the desired functions. Additionally, as one other example, control logic 1100 can be implemented utilizing software such as, for example, a software application designed to run on a personal computer or other computing device, or to run on a processor that may be included with one or more of the electronic devices associated with the network. Thus, for example, in one embodiment, control logic 1100 can be a software application configured to run on the Windows® operating system and perform desired monitoring, measurement, analysis, or reporting functions while running on the operating system. As another example, control logic 1100 can be software code configured to run on a processor associated with another electronic device such as, for example, a baseband processor of a cellular telephone 1010.

Storage medium 1140 can be implemented utilizing any of a number of memory or storage devices such as, for example, RAM, ROM, Flash memory, discs and disc drives, fixed and removable storage media, volatile and non-volatile storage, and other known or yet-to-be-developed storage media. Storage medium 1140 can be utilized to store data that may be obtained by the network monitoring device (as discussed in detail below). Additionally, data storage 1140 can be configured to contain software algorithms, programs, instructions and other computer readable code used to perform the functions associated with control logic 1100. Other computer readable media can also be provided such as, for example, a communication channel (wired or wireless) that can deliver data, information and program code to and receive data, information and program code from control logic 1100. Thus, executable code can be provided to a processor or other device via memory or storage devices such as those described above, or via a hard wired or wireless communication channel such as, for example, a software download via a network. This communication interface can be provided, for example, by the various communications interfaces illustrated in FIG. 2, or by any other communications interface.

A user interface 1120 can be provided to allow reporting and other information transfer to a user of the device. For example, a graphical user interface, a textual user interface, or other visual display can be provided such that a user can obtain information from the network monitoring device. Additionally, other audio, visual, or other sensory interfaces can be provided to allow communication of information from the network monitoring device to a user, and also to allow a user to enter commands, data, or other information into the network monitoring device. Examples of the types of data or other information that may be communicated between the user and the network monitoring device via a user interface 1120 are discussed in greater detail below.

In yet another embodiment, in addition to or in place of a user interface 1120, data and other information can be exchanged with the network monitoring device via electronic means to another device or apparatus. This can be accomplished via the network it is monitoring, or alternatively via another data channel. Thus, the example illustrated in FIG. 2 includes a data port 1180. Data port 1180 can be utilized to, for example, transfer information obtained from the network to another device, allow commands or other control information to be downloaded to the network monitoring device, and allow other information to be exchanged as well. In another embodiment, some or all of this data information transfer can be accomplished via the network monitoring device's network interface (e.g., via signal conversion 1130 and wireless transceiver 1150).

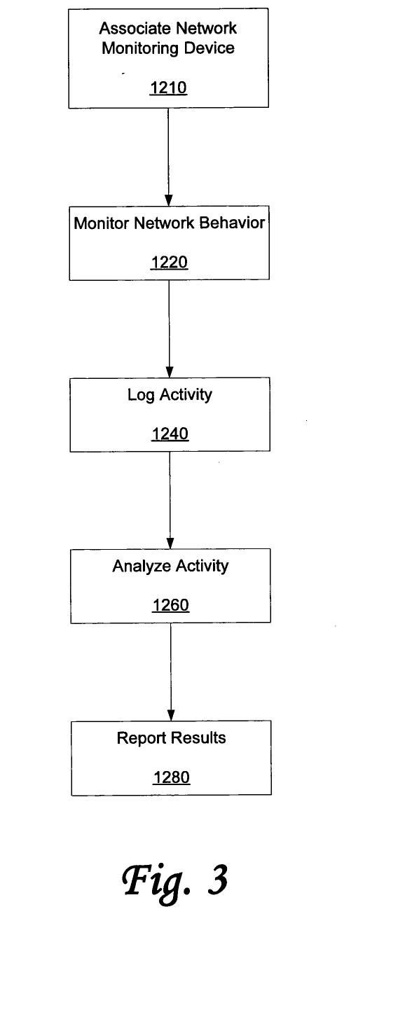

Having thus described an example architecture for the network monitoring device, additional features and functionality of the invention are now described in terms of an example operational flow. FIG. 3 is an operational flow diagram illustrating the operation of the network monitoring device in accordance with one embodiment of the invention. Preferably, to enable the network monitoring device to monitor the network, it is first associated with the network. In other words, it can become a member of the network or otherwise be placed in communicative contact with devices on the network. Therefore, as illustrated above with reference to FIG. 2, the network monitoring device is provided with the appropriate network interface functionality to allow it to communicate with and preferably be a part of the network neighborhood. Thus, in a step 1210, the network monitoring device is associated with the network. This association can be a full association, wherein the network monitoring device becomes a part of the network, as are the other electronic devices associated with that network. In this configuration, the network monitoring device can have full transmit and receive capabilities and transfer data, content, or other information in a bi-directional fashion with other electronic devices across the network.

Alternatively, the network monitoring device can be implemented so as to merely monitor the network and only receive information about the network such as, for example, from other communication devices. Depending on the functionality desired, it is not necessary that the network monitoring device transmit information to other devices across the network. For example, in an implementation where the network monitoring device is a stand-alone device and has a GUI interface to provide information to a user, the communication interface (for example, transceiver 1150) can be configured as a receiver only and the results of the monitoring, measuring, and/or analysis can be provided to the user via the GUI without the need for electronically exporting information via a transmitter or data port 1180. Also, the network monitoring device can be configured to provide the results of the monitoring, measuring, and/or analysis to the user or to another device via a communicative coupling other than the network being monitored.

In a step 1220, once connected to the network, the network monitoring device monitors network behavior. For example, in the specific example environment of the MB-UWB network, the network standard dictates a Beacon Period wherein the various electronic devices communicate housekeeping and other information to one another across the network. For example, the Beacon Period may be used to allow the devices to register themselves with the network, indicate that they are going to sleep or waking up on the network, indicate bandwidth reservations in upcoming data frames, and other like housekeeping information. Thus, in one embodiment, the network monitoring device monitors the signals received by other devices on the network during the Beacon Period.

In addition to monitoring the Beacon Period, the network monitoring device can be configured so as to transmit information in its own beacon that may be used by other associated devices to improve or optimize network performance. Thus, in one embodiment, the network monitoring device comprises higher quality or better performing components and can facilitate the performance of other components on the network. Additionally, in one embodiment, the network monitoring device is used to communicate modified, new or otherwise updated parameters to the associated devices. These parameters can be received by the associated devices and the devices can update their performance or behavior to conform to these modified or new parameters. This can permit, for example, network standards, benchmarks and recommendations to be updated by the network monitoring device in this fashion. Thus, network operating procedures, whether required, recommended, or merely requested, can be updated in this fashion.

In alternative embodiments or implementations, other techniques can be used to ascertain various operating parameters of the devices on the network similar to the information obtained during a Beacon Period in the MB-UWB network standard. For example, in another embodiment, the network monitoring device can be configured to monitor the activity of the other devices associated with the network during non-beacon periods. Thus, monitoring the operation of the devices in this manner allows the network monitoring device to determine whether the other associated devices are following (and in one embodiment to what extent) the recommended or required standards, rules or policies of the network. For example, it can determine whether one or more associated devices are wasting network bandwidth.

In terms of the example architecture illustrated in FIG. 2, the network monitoring occurs by the network monitoring device receiving wireless data signals from wireless network 1020 and downconverting and demodulating those signals via its receiver 1150 and signal conversion 1130 into a format that is usable by control logic 1100.

In a step 1240, network activity ascertained during the monitoring period can be logged such as, for example, in data storage 1140. Logging of activity can be used to allow network devices and their parameters to be monitored over a period of time to ascertain their behavior over a selected time period. For example, logging activity over a period of time can allow the network monitoring device to determine whether a particular behavior pattern is intermittent or long term, and can also allow a trend analysis to be performed to determine whether a device is trending in a particular direction. Logging of activity also allows intermittent problems to be detected and their occurrence to be analyzed in conjunction with other events occurring on the network to better identify potential sources for the detected problem. Thus, for example, when intermittent activity occurs and is logged, other logged conditions occurring at or near the time the intermittent problem occurs can be viewed to ascertain possible causes of the intermittent disturbance.

In a step 1260, the monitored activity is analyzed by control logic 1100. This analysis can be done on a real-time or near-real-time basis as information is received by the network monitoring device, or it can be done in a post-processing mode on information that has been logged such as, for example, in step 1240. The analysis can be used to determine whether a device is behaving appropriately in accordance with network standards or other desirable specifications, and can also be used to identify trends, identify rogue or misperforming devices, suggest corrections, and perform other useful analysis. Results of the analysis can also be logged in data storage 1140 for recordkeeping, future uses, or other purposes.

In a step 1280, the results of the analysis are reported. In one embodiment, the reported results are the results of analysis activity conducted in step 1260. In this embodiment, the report can include an identification of malfunctioning devices, the type of malfunction, a cause of the malfunction, a listing of conditions on the network when the malfunction occurs, or other information obtained during analysis. As with the analysis step, reporting can be done on a real-time or near-real-time basis, providing information to a user in real time, and a post-processing mode. Even with post-processing analysis, some level of real-time or near-real-time reporting of events and information can be provided.

In another embodiment, the reported results can comprise a report of activity logged via the network such that a user or another device can be utilized to analyze what is happening in the network based on the activity logged. Thus, for example, the network monitoring device can be purely a monitoring device that simply logs activity and reports logged activity to the user or another device. Thus, the user or the other device can review the monitored activity, perform any analysis, and arrive at conclusions as to the performance of the network and its various electronic devices as a result of the monitored activity.

As discussed above, in one embodiment, the reporting can be performed via a GUI (Graphical User Interface) or other interface to a user such that the user can be informed via text, graphics, or other sensory means regarding information obtained by the network monitoring device. For example, the network monitoring device may, via a GUI, report to the user that network performance is suboptimal because a particular electronic device on the network is consuming more than its allotted bandwidth or regularly consuming close to the maximum allotted bandwidth. This can allow the user to take corrective action such as, for example, removing the offending device, using the offending device only during non-peak periods, or other corrective action as may be appropriate.

In another embodiment, the results can be reported electronically to another electronic device such as, for example, a personal computer, a cellular telephone, a PDA, or other electronic device. In one embodiment, this communication is made via the network being analyzed and the results communicated to a device associated with the network. In another embodiment, the communication is made via an alternative communication channel, such as, for example via a data port 1080. Thus, communication can be made to an electronic device whether or not that electronic device is associated with the network.

In a preferred embodiment, the functions described above such as monitoring, analyzing, logging and reporting on network activities can be performed by control logic 1100, either in a stand alone device or distributed across multiple devices. Thus, in one embodiment, control logic 1100 can be described as having several modules, although these need not be discreet modules. These modules can include, for example, a monitoring module to monitor network and device activity, an analysis module to perform the analysis activities of the network monitoring device, a logging module to coordinate storage and recall of data and information, and a reporting module to handle reporting of information to users or other devices. As described above with reference to FIG. 1, control logic 1100, including its various modules, can be implemented utilizing hardware or software (including firmware, etc.) or any combination thereof.

As described herein, several embodiments of the network monitoring device are contemplated depending on the functions or functionality desired. For example, in one embodiment, the network monitoring device can be implemented as a stand-alone device, configured to perform monitoring of the network. In this embodiment, the stand-alone network monitoring device can include a receiver configured to receive information from the network, control logic to process the information, and a user interface to display the information, whether that information be logged activity or analyzed activity. Thus, with a stand-alone environment, a user can bring the monitoring device in contact with his or her network, allow it to monitor network activity for a desired period of time, and determine based on information provided via the user interface the health of his or her network. In embodiments where only activity logging is performed by the network monitoring device, the user interface would display the monitored activity, allowing the user to make determinations as to the performance of the network and whether various electronic devices associated with the network are operating properly.

In another embodiment, the network monitoring device can operate in a quasi-stand-alone mode. Thus, for example, in this embodiment, the network monitoring device can still include a user interface to provide logged activity, analyzed activity, or other information to a user as well as the capability to transmit such information to another device. For example, in this embodiment, the network communication interface (for example, transceiver 1150) or a data port 1180 can be used to provide logged activity or analyzed activity to another device. In this embodiment, the other device can be configured to perform analysis and reporting as desired based on the information received by the network monitoring device. One example application is now used to illustrate functionality that can be included with this embodiment of the invention. Consider a situation where, for example, a network administrator or other individual desires to check the health and status of one or more networks in a home, office, or other setting.

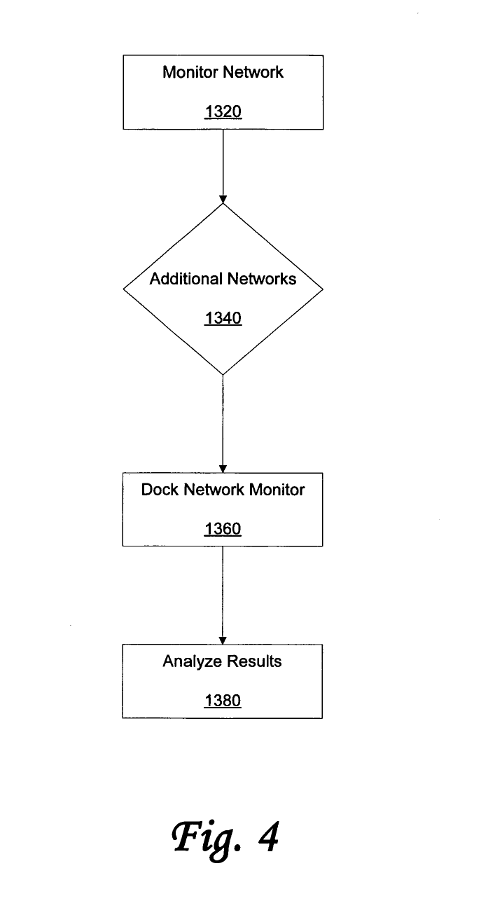

FIG. 4 is an operational flow diagram illustrating an example process for monitoring one or more networks in accordance with one embodiment of the invention. Referring now to FIG. 4, in a step 1320, the network monitoring device is configured to monitor the network with which it is associated or from which it is otherwise receiving data or other information. The data and any other desired information is collected for a predetermined or desired period of time. Preferably, the amount of time monitored is chosen so as to allow the network monitoring device to collect a sufficient amount of data such that electronic devices and, indeed, the network overall, can be assessed and characterized. Preferably, the data collected is stored in a local storage device such that it can be retrieved for subsequent review. In some embodiments, onboard processing capability is provided to allow the network monitoring device to analyze the collected data as it is collected from the network, either in real time or in a batch processing mode.

If the network administrator or other user desires to analyze additional networks, the network monitoring device can be brought to within range of that network, associated with that network or otherwise put into communicative coupling with that network, and the network monitored as illustrated by steps 1340 and 1320. As with the first network, subsequent networks can be monitored for a predetermined or desired period of time and the data collected and, if desired, analyzed by the network monitoring device. Results of the network monitoring and any analysis performed by the network monitoring device for one or more of the networks monitored can be performed by the user in real time or after the monitoring is completed for one or more of the networks. For network monitoring devices that provide a GUI or other user interface, the interface can be consulted to determine the health, status, or other characteristics of the network and the various electronic devices associated therewith. For example, the user can in some embodiments be immediately informed of one or more devices that may be behaving in a substandard fashion. Corrective action can be immediately taken or taken as deemed appropriate by the user or other network manager.

In some embodiments, the user may desire to gather information on multiple networks and return that information to a central computing device for further analysis and reporting. For example, a network administrator in an office building may wish to gather information on a plurality of wireless networks operating within the office building. In this embodiment, the administrator can travel from network area to network area and conduct the monitoring as discussed above with reference to steps 1320 and 1340. Where a display or other user interface is provided, the network administrator can review data along the way, if desired, and take any appropriate corrective action that may be desired as well.

Alternatively, when the user has analyzed the desired number of networks, he or she can then bring the network monitoring device back to his or her desired computing device, on which further analysis can be undertaken. This is illustrated by a step 1360, in which the network monitoring device is docked or otherwise put in communicative coupling with the computing device. For example, the administrator may dock the network monitoring device to his or her desktop computer by any of a number of docking means including, for example, a USB connection, a wireless connection, or any other communicative connection. The administrator can then perform analysis of the networks monitored using functionality that may be present on his or her personal computer. This is illustrated by a step 1380.

Alternatively, all of the analysis can be performed by the network monitoring device itself, and reports and other graphical information presented to the user via the administrator's computing device. In one embodiment, additional processing capability can be provided to allow the analysis to consider the effects that devices in one network may have on neighboring networks and other cross-network effects. For example, a given device may be detected by the network monitoring device on more than one of the analyzed networks. Thus, corrective action can be taken to ensure that the given device is communicating only with its intended networks, if so desired. Additionally, effects such as network hopping may be detected as well as a result of this multi-network analysis.

In yet another embodiment, multiple network monitoring devices in one or more varying configurations can be used to monitor one or more networks. They can be used to gather real-time data or to collect data over time, and the data can be analyzed to determine the overall health of the network. This can be particularly useful in situations where, for example, one network monitoring device cannot be placed in a position so as to ‘see’ all the devices associated with a network. Thus, this can help detect and analyze hidden nodes.

Additionally, multiple devices may be used to triangulate the position of other network devices. This can be useful for locating devices. Additionally, position determination can be used to aid in the analysis of a device's performance such as, for example, its transmitter power. One monitoring device can determine whether the signal it receives from another device is weak. However, this perceived weakness may be due to distance of the devices relative to each other rather than symptomatic of a poorly performing transmitter. For example, wireless signals typically drop off as a function of the square of the distance from the source. However, with multiple detection devices and position determination, a device's signal strength can be evaluated based on the device's position and thus, distance, from the receiver at which the signal strength is measured.

Of course, a network monitoring device can be configured to report low signal strengths regardless of whether the monitoring device can qualify this assessment such as for example, by correlating signal strength with distance from the device. In this embodiment a user may be able to ascertain whether the low signal strength is a result of distance, outside interference or some other external factor, or whether it is symptomatic of the transmitter's health.

Another feature of the invention can be included to provide detection of the effect of devices entering and leaving the network coverage area, whether or not they actually join the network. For example, an office may have one or more networks that are affected by passersby carrying mobile devices into and out of one or more network areas. These devices can impact a network (for example, by interference) even if they do not join the network. Thus, the network monitoring device can be configured to detect their presence and monitor the effects thereof.

Still another feature of the invention is that statistics, trends, and other data can be tracked and compiled and analyzed to better aid a user in crafting solutions to network problems or improving network performance.

Yet another feature of the invention can be included to provide security for a given wireless network. A user can use the network monitoring device to inform the user of whether and if an unauthorized device becomes associated with the network. For example, this can be accomplished by simply viewing a report of the devices listed as being associated with the network during monitoring periods. Additionally, the monitoring tool can be configured with a list of allowed devices such that the list of detected devices can be compared with the list of allowed devices to determine whether there are any unwanted devices on the network. In an embodiment such as this, the network monitoring device can be configured to automatically raise an alert or other flag when an unauthorized device is detected. For example, information via the user interface can be provided to the user to alert the user of the unwanted device. This can include, for example, a message on a user screen (graphics or textual), a flashing alert, a beep or other sound, a tactile alert (for example, a vibrating sensation), or other sensory output. Additionally, the device can be configured to provide an indication of an unwanted device to another network device such as, for example, a computer on the network, so that that device can provide an alert to the user. In yet another embodiment, the network monitoring device can be configured to provide an alert to one or more of the other electronic devices on the network warning or instructing them not to accept data from or provide data to the unwanted device.

Unwanted devices can be identified based on a number of parameters or characteristics including, for example, device identification. Additionally, devices can be listed as allowed or disallowed from the network based on a device class or a type of device. In addition to informing the network administrator or user that a non-approved device is associated with the network, the present invention can be implemented so as to inform other approved network devices of the existence of the rogue device. In this way, other devices on the network can be instructed to ignore communications from and not send communications to the non-approved device. Additionally, other security measures can be implemented or stepped up in the event that a non-approved device is located. For example, a network may be configured such that encryption or other security measures are optional or not always implemented. In this embodiment, when the non-approved device is found, the present invention can be configured so as to instruct all of the approved devices to implement the security measures. For example, the approved devices can be instructed to implement encryption using predefined keys or other code words such that their communications are unintelligible to the non-approved device. Of course, once the non-approved device has been disabled or otherwise removed from the network, the invention can be configured so as to return the network to its standard operating configuration.

In yet another embodiment of the invention, one or more electronic devices associated with the network may be configurable either manually or electronically. Thus, when a sub-standard electronic device is identified on the network, there is the potential opportunity to reconfigure the device to bring it into conformance. For example, a device may have configurable transmitter power settings, data rate settings, or other parameter settings that can be adjusted to allow the device to conform to the specified parameters for that network. Thus, for example, if it is determined that the network performance is suboptimal because one of the devices is not transmitting at an appropriate or optimal data rate, the network monitoring device as a result of its monitoring functions can detect this deficiency.

In one embodiment, the network monitoring device can send an appropriate control signal to the substandard electronic device containing information directing the device to modify its settings in an effort to conform to established metrics or desired performance parameters. For example, where an offending device's center frequency, data rate, number of retries, time between retries, or other characteristic is out of specification, the control signal can be a signal directing the offending device to adjust this parameter accordingly. Alternatively, the network monitoring device can inform the user, either via its user interface or by way of another electronic device, such as the user's PC, for example, that the device is substandard in terms of the subject characteristic such that the user can properly adjust the device. Of course, other parameters can be hard or soft configurable in this way, such that the network can be optimized based on results obtained by the network monitoring device.

In one embodiment, instead of or in addition to adjusting the device identified as substandard, the network deficiency may be cured by adjusting the parameters of other devices on the network. Of course, there are practical limits to device settings, and some devices may not be configured to permit such adjustments. However, these examples serve to illustrate just a few ways in which a network performance can be improved based on information obtained through the monitoring and analysis of a network and its various electronic devices.

In yet another embodiment of the invention, the present invention can be configured so as to compensate for deficiencies in an electronic device. For example, where the network monitor determines that one device is transmitting with insufficient power for other devices to detect its communications, the present invention can act as a repeater to provide information to other network devices that may be unable to receive the weak signal. In another embodiment of the invention, the network monitor can be configured so as to provide aggregated information about the network to other network devices. Thus, in the example environment, for example, the present invention may be configured so as to create an aggregate view of the information obtained by monitoring the other network devices, and provide this aggregated information to the other devices. This can be done, for example, during the Beacon Period in the MB-UWB environment. The other devices can be configured to use this aggregated information in conforming their own behavior on the network based on network characteristics. For example, one or more devices may determine that there are particular network periods where bandwidth is at a premium and they may thus conform their own bandwidth usages to other network time slots so as to make a more optimum use of available bandwidth. Additionally, as another example, when looking at the aggregated information, one or more devices may determine that they can adjust their characteristics to give them a better view of the network or to enhance their performance on the network. Additionally, this aggregated information can be used by the user to make such adjustments or by the present invention as discussed above.

As described above, the present invention can be configured with transmit, receive, or transceiver capabilities. In one embodiment, it may be desirable to implement the present invention with only receive capabilities, as its primary function may be to monitor and analyze the network rather than provide information back to the network or to devices by way of the network. In some embodiments, the transceiver data rate may be reduced for the present invention, especially in embodiments where the invention is only communicating with the network during the Beacon Period or the like. In these embodiments, Beacon Period data rates are typically much less than actual data transfer data rates utilized during normal network communications outside the Beacon Period.

In embodiments where a user interface is provided, that interface may range in features and capabilities from minimalistic to robust, depending on design preferences and performance goals. For example, a limited display of one or more indicator lights can be provided simply to provide a status indication of one or more features of the network. For example, there may be one or more indicator lights indicating features such as acceptable or suboptimal network performance, presence of a rogue device, and other like characteristics. In a less minimalistic approach, a somewhat limited display can be provided to simply identify an offending device within a network. Thus, providing more information that simple indicator lights, this display can identify an offending device, for example, by name, ID, class, or other identifier suitable to point the troubleshooter in the right direction. In a more robust example, a graphical user interface can be provided to provide the user with graphic and textual information about the network and the devices thereon. This interface can include information such as, for example, network status information, a listing of devices detected on the network, performance characteristics of the devices on the network, a listing of substandard devices on the network, a description of deficiencies with the substandard devices, and so on.

Additionally, graphical information can be provided such as signal strength meters for one or more devices, network traffic indicators, real time or non-real time traffic flow diagrams, diagrams indicating resource utilization by device, and other like information. Utilizing a graphical user interface in this manner can provide the user with a wealth of information in a readily ascertainable format. As described in one or more embodiments above, the present invention can be implemented as a stand-alone device or in conjunction with one or more electronic devices on the network. Thus, for example, the user interface portion can be implemented as a Windows screen on a computer display, using the display of a PDA or cell phone, or in another like configuration. Thus, capabilities such as processing, graphics, and display capabilities that may already exist in other devices on the network can be utilized on those devices rather than duplicated in the network monitoring device. In a similar manner, processing capabilities in other devices on the network can be utilized to provide one or more of the functions described with reference to the present invention.

While various embodiments of the present invention have been described above, it should be understood that they have been presented by way of example only, and not of limitation. Thus the breadth and scope of the present invention should not be limited by any of the above-described exemplary embodiments, but should be defined only in accordance with the following claims and their equivalents. Additionally, the invention is described above in terms of various exemplary embodiments and implementations. It should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment.

Terms and phrases used in this document, and variations thereof, unless otherwise expressly stated, should be construed as open ended as opposed to limiting. As examples of the foregoing: the term “including” should be read to mean “including, without limitation” or the like; the term “example” is used to provide exemplary instances of the item in discussion, not an exhaustive or limiting list thereof; and adjectives like “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise.

1. A network monitoring device, configured to monitor the performance of a wireless communication network, the network monitoring device comprising:
a wireless communication interface configured to associate the network monitoring device with the communication network and to receive device parameter information from one or more electronic devices associated with the network,
first control logic configured to monitor device parameter information received by the wireless communication interface to ascertain one or more operating parameters of at least one of the plurality of electronic devices associated with the network;
second control logic configured to analyze the operating parameters of electronic devices associated with the wireless communication network to determine whether one or more of the electronic devices associated with the wireless communication network are operating in accordance with network specifications; and
third control logic configured to report the results of the analysis performed by the second control logic.

2. The network monitoring device of claim 1, wherein the wireless communication interface comprises a wireless receiver and a signal conversion module configured to receive wireless signals from the wireless communication network and to convert information received thereby into a format that is intelligible by the first control logic.

3. The network monitoring device of claim 1, further comprising a user interface configured to provide a user with information concerning whether one or more of the electronic devices associated with the wireless communication network are operating outside of network specifications.

4. The network monitoring device of claim 3, wherein the user interface comprises at least one of a graphical, textual, audible or tactile interface.

5. The network monitoring device of claim 1, further comprising fourth control logic configured to take corrective action to resolve a situation where one or more of the electronic devices associated with the wireless communication network are operating outside of network specifications.

6. The network monitoring device of claim 5, wherein the fourth control logic is configured to send control information to the electronic device operating outside of network specifications, wherein the control information is operable to adjust one or more operating parameters of that electronic device.

7. The network monitoring device of claim 5, wherein the third control logic is configured to send control information to electronic devices associated with the wireless communication network, wherein the control information is operable to adjust one or more operating parameters of the electronic devices.

8. The network monitoring device of claim 1, further comprising fourth control logic configured to store information pertaining to the wireless communication network, the information comprising at least one of monitoring information determined by the first control logic and analysis information determined by the second control logic.

9. The network monitoring device of claim 1, further comprising fourth control logic configured to send updated operating parameters to at least one of the plurality of devices associated with the network to update network operating procedures for the communication network.

10. The network monitoring device of claim 1, wherein said second control logic is configured to analyze the operating parameters on at least one of a real-time, a near-real-time and a post-processing basis.

11. A network monitoring system configured to monitor performance of a communication network having a plurality of electronic devices, comprising;
a network monitoring module configured to monitor communication activities occurring on the communication network;
an analysis module configured to determine whether one or more of the plurality of electronic devices are operating in accordance with at least one of a plurality of performance metrics; and
a reporting module configured to report the results of the performance information including an identification of an electronic device that is not operating in accordance with at least one of a plurality of performance metrics.

12. The network monitoring system of claim 11, further comprising a logging module configured to store information concerning activity ascertained as a result of network monitoring.

13. The network monitoring system of claim 12, wherein the analysis module is further configured to analyze network performance over a period of time.

14. The network monitoring system of claim 11, further comprising a user interface configured to provide a user with information concerning whether one or more of the electronic devices associated with the communication network are operating outside of network specifications.

15. The network monitoring system of claim 14, wherein the user interface comprises at least one of a graphical, textual, audible or tactile interface.

16. The network monitoring system of claim 11, further comprising control logic configured to take corrective action to resolve a situation where one or more of the electronic devices associated with the communication network are operating outside of network specifications.

17. The network monitoring system of claim 16, wherein the control logic is configured to send control information to the electronic device operating outside of network specifications, wherein the control information is operable to adjust one or more operating parameters of that electronic device.

18. The network monitoring system of claim 16, wherein the control logic is configured to send control information to electronic devices associated with the communication network, wherein the control information is operable to adjust one or more operating parameters of the electronic devices.

19. The network monitoring system of claim 11, further comprising control logic configured to store information pertaining to the wireless communication network, the information comprising at least one of monitoring information determined by the first control logic and analysis information determined by the second control logic.

20. The network monitoring system of claim 11, wherein at least one of the modules is implemented using hardware, software or a combination of hardware and software.

21. The network monitoring system of claim 11, further comprising a module configured to send updated operating parameters to at least one of the plurality of devices associated with the network to update network operating procedures for the communication network.

22. The network monitoring device of claim 11, wherein said analysis module is configured to analyze the operating parameters on at least one of a real-time, a near-real-time and a post-processing basis.

23. A network monitoring device, configured to monitor the performance of a communication network having a plurality of electronic devices associated therewith, the network monitoring device comprising:
first control logic configured to receive one or more operating parameters from at least one of the plurality of electronic devices associated with the network;
second control logic configured to analyze the operating parameters of electronic devices associated with the network to determine whether one or more of the electronic devices are operating in accordance with network specifications; and
third control logic configured to report the results of the analysis performed by the second control logic.

24. The network monitoring device of claim 23, further comprising a communication interface configured to allow the network monitoring device to communicate with one or more of the electronic devices associated with the communication network.

25. The network monitoring device of claim 24, wherein the communication interface comprises a wireless receiver and a signal conversion module configured to receive wireless signals from a wireless communication network and to convert information received thereby into a format that is intelligible by the first control logic.

26. The network monitoring device of claim 23, further comprising a communication interface configured to allow the network monitoring device to communicate with an electronic device via a communication path other than the communication network.

27. The network monitoring device of claim 23, further comprising a user interface configured to provide a user with information concerning whether one or more of the electronic devices associated with the communication network are operating outside of network specifications.

28. The network monitoring device of claim 27, wherein the user interface comprises at least one of a graphical, textual, audible or tactile interface.

29. The network monitoring device of claim 23, further comprising third control logic configured to take corrective action to resolve a situation where one or more of the electronic devices associated with the communication network are operating outside of network specifications.

30. The network monitoring device of claim 29 wherein the third control logic is configured to send control information to the electronic device operating outside of network specifications, wherein the control information is operable to adjust one or more operating parameters of that electronic device.

31. The network monitoring device of claim 29, wherein the third control logic is configured to send control information to electronic devices associated with the wireless communication network, wherein the control information is operable to adjust one or more operating parameters of the electronic devices.

32. The network monitoring device of claim 23, further comprising fourth control logic configured to store information pertaining to the communication network, the information comprising at least one of monitoring information determined by the first control logic and analysis information determined by the second control logic.

33. The network monitoring device of claim 23, wherein the control logic is implemented using hardware, software or a combination of hardware and software.

34. The network monitoring device of claim 23, further comprising fourth control logic configured to send updated operating parameters to at least one of the plurality of devices associated with the network to update network operating procedures for the communication network.

35. The network monitoring device of claim 23, wherein said second control logic is configured to analyze the operating parameters on at least one of a real-time, a near-real-time and a post-processing basis.

36. A network monitoring device, configured to monitor the performance of a communication network having a plurality of electronic devices associated therewith, the network monitoring device comprising:
means for receiving one or more operating parameters from at least one of the plurality of electronic devices associated with the network;
means for analyzing the operating parameters of electronic devices associated with the network to determine whether one or more of the electronic devices are operating in accordance with network specifications; and
means for reporting the results of the analysis performed by the second control logic.

37. The network monitoring device of claim 36, further comprising means for communicating with one or more of the electronic devices associated with the communication network.

38. The network monitoring device of claim 36, further comprising means for communicating with an electronic device via a communication path other than the communication network.

39. The network monitoring device of claim 36, further comprising user interface means for providing a user with information concerning whether one or more of the electronic devices associated with the communication network are operating outside of network specifications.

40. The network monitoring device of claim 39, wherein the user interface means comprises at least one of a graphical, textual, audible or tactile interface.

41. The network monitoring device of claim 36, further comprising means for addressing a situation where one or more of the electronic devices associated with the communication network are operating outside of network specifications.

42. The network monitoring device of claim 36, further comprising means for sending control information to the electronic device operating outside of network specifications, wherein the control information is operable to adjust one or more operating parameters of that electronic device.

43. The network monitoring device of claim 36, further comprising means for sending control information to electronic devices associated with the communication network, wherein the control information is operable to adjust one or more operating parameters of the electronic devices.

44. The network monitoring device of claim 36, further comprising means for storing information pertaining to the communication network, the information comprising at least one of monitoring information determined by the first control logic and analysis information determined by the second control logic.

45. The network monitoring device of claim 36, further comprising means for sending updated operating parameters to at least one of the plurality of devices associated with the network to update network operating procedures for the communication network.

46. A method for monitoring a communication network having a plurality of electronic devices associated therewith, the method comprising the steps of:
receiving one or more operating parameters from at least one of the plurality of electronic devices associated with the network;
analyzing the operating parameters of electronic devices associated with the network to determine whether one or more of the electronic devices are operating in accordance with network specifications; and
reporting the results of the analysis performed by the second control logic.

47. The method of claim 46, further comprising a step of communicating with one or more of the electronic devices associated with the communication network.

48. The method of claim 46, further comprising a step of communicating with an electronic device via a communication path other than the communication network.

49. The method of claim 46, further comprising a step of providing a user with information concerning whether one or more of the electronic devices associated with the communication network are operating outside of network specifications.

50. The method of claim 46, further comprising a step of addressing a situation where one or more of the electronic devices associated with the communication network are operating outside of network specifications.

51. The method of claim 46, further comprising a step of sending control information to the electronic device operating outside of network specifications, wherein the control information is operable to adjust one or more operating parameters of that electronic device.

52. The method of claim 46, further comprising a step of sending control information to electronic devices associated with the communication network, wherein the control information is operable to adjust one or more operating parameters of the electronic devices.

53. The method of claim 46, further comprising a step of storing information pertaining to the communication network, the information comprising at least one of monitoring information determined by the first control logic and analysis information determined by the second control logic.

54. The method of claim 46, further comprising a step of sending updated operating parameters to at least one of the plurality of devices associated with the network to update network operating procedures for the communication network.

55. The network monitoring device of claim 46, wherein said step of analyzing is performed on at least one of a real-time, a near-real-time and a post-processing basis.

56. A computer readable storage medium having computer executable program code thereon configured to monitor the performance of a communication network having a plurality of electronic devices associated therewith, the computer executable program code comprising:
first code directed to receiving one or more operating parameters from at least one of the plurality of electronic devices associated with the network;
second code directed to analyzing the operating parameters of electronic devices associated with the network to determine whether one or more of the electronic devices are operating in accordance with network specifications; and
third code directed to reporting the results of the analysis performed by the second control logic.

57. The computer executable program code of claim 56, further comprising code directed to communicating with one or more of the electronic devices associated with the communication network.

58. The computer executable program code of claim 56, further comprising code directed to communicating with an electronic device via a communication path other than the communication network.

59. The computer executable program code of claim 56, further comprising code directed to providing a user with information concerning whether one or more of the electronic devices associated with the communication network are operating outside of network specifications.

60. The computer executable program code of claim 56, further comprising code directed to addressing a situation where one or more of the electronic devices associated with the communication network are operating outside of network specifications.

61. The computer executable program code of claim 56, further comprising code directed to sending control information to the electronic device operating outside of network specifications, wherein the control information is operable to adjust one or more operating parameters of that electronic device.

62. The computer executable program code of claim 56, further comprising code directed to sending control information to electronic devices associated with the communication network, wherein the control information is operable to adjust one or more operating parameters of the electronic devices.

63. The computer executable program code of claim 56, further comprising code directed to storing information pertaining to the communication network, the information comprising at least one of monitoring information determined by the first control logic and analysis information determined by the second control logic.

64. The computer executable program code of claim 56, further comprising code directed to sending updated operating parameters to at least one of the plurality of devices associated with the network to update network operating procedures for the communication network.

65. The network monitoring device of claim 56, wherein said code performs the analysis on at least one of a real-time, a near-real-time and a post-processing basis.
